(19) United States
(12) Patent Application Publication
(10) Pub. No.: US 2019/0071962 A1
(43) Pub. Date: Mar. 7, 2019

(54) SUBSEA ACOUSTIC POWER SYSTEMS AND METHODS

(71) Applicant: OneSubsea IP UK Limited, London (GB)

(72) Inventors: Emanuel Gottlieb, Pittsburgh, PA (US); Rolf Rustad, Radal (NO); Alek Cywinski, Celle (DE)

(21) Appl. No.: 15/696,877

(22) Filed: Sep. 6, 2017

(51) Int. Cl. E21B 47/00; E21B 47/14; E21B 33/06; E21B 33/064; H04B 13/02

(52) U.S. Cl. CPC E21B 47/0001; E21B 47/14; H04B 13/02; E21B 33/064; E21B 33/061

(57) ABSTRACT

An apparatus for using acoustic energy to provide operational power to a sensor of a subsea installation, such as a subsea well installation, is provided. In one embodiment, the apparatus includes a subsea installation in a body of water, with the subsea installation including a sensor and an acoustic receiver. The apparatus also includes an acoustic transmitter for transmitting acoustic waves to the acoustic receiver using the body of water as a transmission medium. The acoustic receiver is coupled to the sensor so that the sensor can be powered with electricity generated from the acoustic waves received at the acoustic receiver from the acoustic transmitter. Additional systems, devices, and methods are also disclosed.

### BACKGROUND

This section is intended to introduce the reader to various aspects of art that may be related to various aspects of the presently described embodiments. This discussion is believed to be helpful in providing the reader with background information to facilitate a better understanding of the various aspects of the present embodiments. Accordingly, it should be understood that these statements are to be read in this light, and not as admissions of prior art.

In order to meet consumer and industrial demand for natural resources, companies often invest significant amounts of time and money in finding and extracting oil, natural gas, and other subterranean resources from the earth. Particularly, once a desired subterranean resource such as oil or natural gas is discovered, drilling and production systems are often employed to access and extract the resource. These systems may be located onshore or offshore depending on the location of a desired resource.

Further, such systems generally include a wellhead assembly mounted on a well through which the resource is accessed or extracted. These wellhead assemblies may include a wide variety of components, such as spools, hangers, blowout preventers, and trees, that facilitate drilling or production operations. In offshore systems, risers are often used to couple the wellhead assembly to a platform or vessel at the surface of the water. Sensors are used in drilling and production systems to acquire data, and various cables can be used to provide operating power to the sensors.

### SUMMARY

Certain aspects of some embodiments disclosed herein are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

Embodiments of the present disclosure generally relate to power systems that use acoustic energy to provide operational power to electronic devices. In some instances, these power systems are used to facilitate operation of sensors or other electronic devices of a subsea installation, such as a well assembly. The power systems can include acoustic transmitters that radiate acoustic energy through seawater or another transmission medium to acoustic receivers that generate electric power in response to received acoustic energy. The generated electric power can be converted and used to power sensors directly, or to charge an energy storage device (e.g., a battery or a capacitor) from which the sensors draw power. Examples of sensors that can be powered in this manner include temperature sensors, pressure sensors, position sensors, flowmeters, and fluid-detection sensors, to name just several. In some embodiments, acoustic energy is used to generate operational power for sensors of marine risers, wellheads, blowout preventers, trees, other wellhead assembly equipment, pipelines, or abandoned wells.

Various refinements of the features noted above may exist in relation to various aspects of the present embodiments. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. Again, the brief summary presented above is intended only to familiarize the reader with certain aspects and contexts of some embodiments without limitation to the claimed subject matter.

### BRIEF DESCRIPTION OF THE DRAWINGS

These and other features, aspects, and advantages of certain embodiments will become better understood when the following detailed description is read with reference to the accompanying drawings in which like characters represent like parts throughout the drawings, wherein:

FIG. 1 generally depicts a well apparatus in the form of an offshore drilling system with sensors that are operated with electric power generated from acoustic energy transmitted wirelessly through a body of water in accordance with one embodiment of the present disclosure;

FIG. 2 depicts a power transmission chain for transmitting acoustic energy and powering a sensor in accordance with one embodiment;

FIG. 3 depicts a transducer array and a beamformer for controlling emission of acoustic energy from the transducer array in accordance with one embodiment;

FIG. 4 depicts a two-dimensional transducer array that may be used to transmit acoustic energy to acoustic receivers in accordance with one embodiment;

FIG. 5 depicts an acoustic transducer with a lens for collimating a beam of acoustic energy in accordance with one embodiment;

FIG. 6 depicts a pipeline having a sensor that is powered via electricity generated by an acoustic receiver in response to acoustic waves in accordance with one embodiment;

FIGS. 7 and 8 each depict an abandoned well having a sensor that is powered via electricity generated by an acoustic receiver in response to acoustic waves in accordance with certain embodiments;

FIG. 9 depicts a vessel that may travel between multiple subsea installations to provide acoustic energy to the installations for powering sensors and to receive data acquired by the sensors in accordance with one embodiment; and

FIG. 10 depicts a blowout preventer having acoustic receivers for generating operating power for internal sensors of the blowout preventer in response to acoustic energy transmitted through the body of the blowout preventer in accordance with one embodiment.

### DETAILED DESCRIPTION OF SPECIFIC EMBODIMENTS

Specific embodiments of the present disclosure are described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time-consuming, but would nevertheless be a routine undertaking of design, fabrication, and manufacture for those of ordinary skill having the benefit of this disclosure.

When introducing elements of various embodiments, the articles “a,” “an,” “the,” and “said” are intended to mean that there are one or more of the elements. The terms “comprising,” “including,” and “having” are intended to be inclusive and mean that there may be additional elements other than the listed elements. Moreover, any use of “top,” “bottom,” “above,” “below,” other directional terms, and variations of these terms is made for convenience, but does not require any particular orientation of the components.

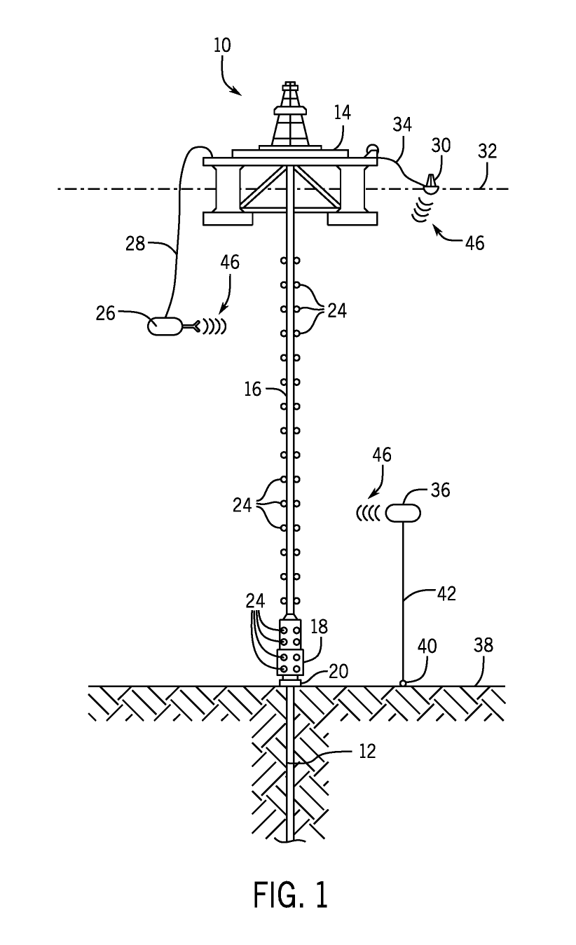

Turning now to the present figures, a well assembly or apparatus 10 is illustrated in FIG. 1 in accordance with one embodiment. The apparatus 10 (e.g., a drilling system or a production system) facilitates access to or extraction of a resource, such as oil or natural gas, from a reservoir through a well 12. The apparatus 10 is generally depicted in FIG. 1 as an offshore drilling apparatus including a drilling rig 14 coupled with a marine riser 16 to a wellhead assembly 18 installed at the well 12. Although shown here as an offshore system, the well apparatus 10 could instead be an onshore system in other embodiments.

As will be appreciated, the drilling rig 14 can include surface equipment positioned over the water, such as pumps, power supplies, cable and hose reels, control units, a diverter, a gimbal, a spider, and the like. Similarly, the riser 16 may also include a variety of components, such as riser joints, flex joints, a telescoping joint, fill valves, and control units, to name but a few. The wellhead assembly 18 includes a wellhead 20 and equipment, such as blowout preventers, coupled to the wellhead 20 to enable the control of fluid from the well 12. Any suitable blowout preventers could be coupled to the wellhead 20, such as ram-type preventers and annular preventers. In at least some embodiments, the wellhead assembly 18 includes a lower marine riser package connected to a lower blowout preventer stack. And the wellhead 20 of the assembly 18 can also include various components, such as casing heads, tubing heads, spools, and hangers.

In this depicted embodiment, the apparatus 10 is a subsea well installation that includes sensors 24 for measuring parameters of interest. Such sensors 24 can include pressure sensors, temperature sensors, position sensors, or fluid-sensing devices, for instance. The sensors 24 are generally shown on the riser 16 and the wellhead assembly 18, but it will be appreciated that sensors 24 could also or instead be provided at other locations in the apparatus 10.

In at least some embodiments, the sensors 24 are operated with electric power generated from acoustic energy received through a body of water (e.g., a sea or ocean). More specifically, the apparatus 10 includes transmitters for radiating acoustic power, via acoustic waves, toward the sensors 24, and the body of water can be used as a transmission medium for the acoustic waves. Acoustic power may be transmitted to the sensors 24 from any suitable location.

The depicted apparatus 10, for example, includes a remotely operated vehicle (ROV) 26 connected to the drilling rig 14 via a tether 28, a buoy 30 at surface 32 of the water and connected to the drilling rig 14 with a tether 34, and a submersible 36 connected to the bed 38 (e.g., a seabed or ocean bed) by an anchor 40 and a tether 42. The ROV 26, the buoy 30, and the submersible 36 include acoustic transmitters for radiating acoustic waves 46 toward the sensors 24, and electric power for the acoustic transmitters is provided by the tethers 28, 34, and 42 in some embodiments. Acoustic transmitters may also or instead be provided elsewhere, such as on the drilling rig 14, on other equipment of the apparatus 10, or on an autonomous underwater vehicle. Acoustic receivers then receive the acoustic waves 46, which generate electrical signals that may be converted and used as operational power for the sensors 24. In at least some instances, the acoustic receivers are located on the riser 16 or the wellhead assembly 18 and generating operational power for the sensors from received acoustic energy enables omission of certain cabling or umbilicals that would otherwise be used to provide power to the sensors.

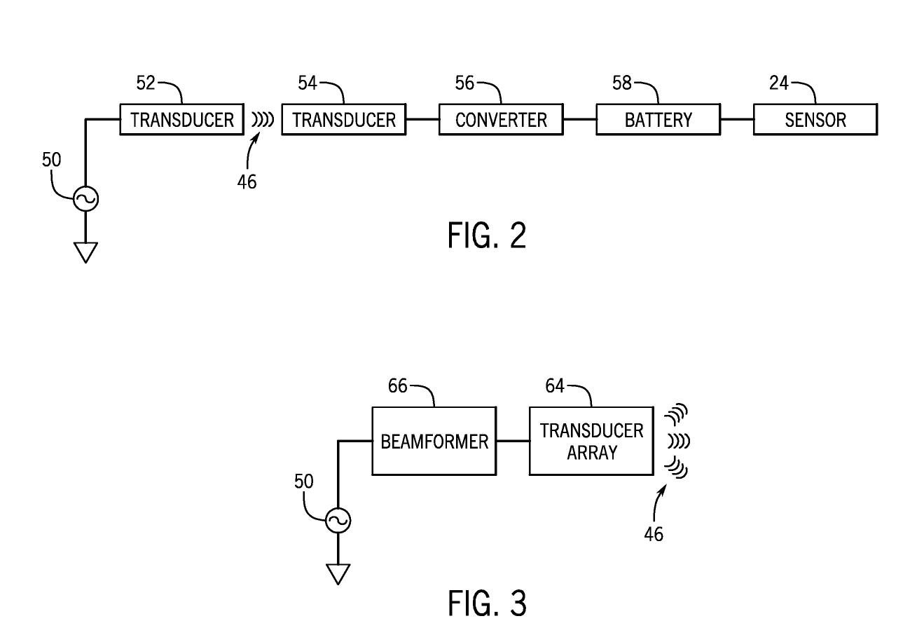

An example of a power transmission chain for transmitting acoustic energy and powering a sensor 24 is generally depicted in FIG. 2. In this embodiment, a power supply 50 provides electric power to an acoustic transmitter, such as an acoustic transducer 52, which emits acoustic waves 46 through a transmission medium, such as the body of water depicted in FIG. 1. An acoustic receiver (e.g., an acoustic transducer 54) receives the acoustic waves 46 and generates alternating current (AC) electric power in response to the acoustic waves 46. In at least some embodiments, this AC power is converted into a desired power by converting circuitry generally depicted as converter 56 in FIG. 2. The converter 56 can include an AC/DC converter, for instance, that converts AC power from the acoustic receiver to direct current (DC) power that is used to power the sensor 24. The converter 56 can include other circuitry, such as a power amplifier that increases power output to the sensor 24. The DC power can be supplied directly to the sensor 24, but in other instances the DC power from the converter 56 indirectly supplies the sensor 24. In one example, the DC power from the converter 56 is used to charge an energy storage device (e.g., a battery 58 or a capacitor bank), and the energy storage device provides operational power to the sensor 24. The portion of the power transmission chain that receives acoustic energy and provides operational power to the sensor 24 (e.g., the acoustic transducer 54, the converter 56, and the battery 58) may be referred to as a sensor power system.

The acoustic transmitters and receivers may take any suitable forms, such as ultrasonic transducers, other acoustic transducers, barrel stave projectors, ring projectors, planar (two-dimensional) transducer arrays, and cylindrical transducer arrays. In some embodiments, receiving transducers 54 are made with piezoelectric materials, such as lead zirconate titanate (PZT) (e.g., single element PZT-5A), lithium niobate, lead magnesium niobate-lead titanate (PMN-PT), or a piezoelectric composite.

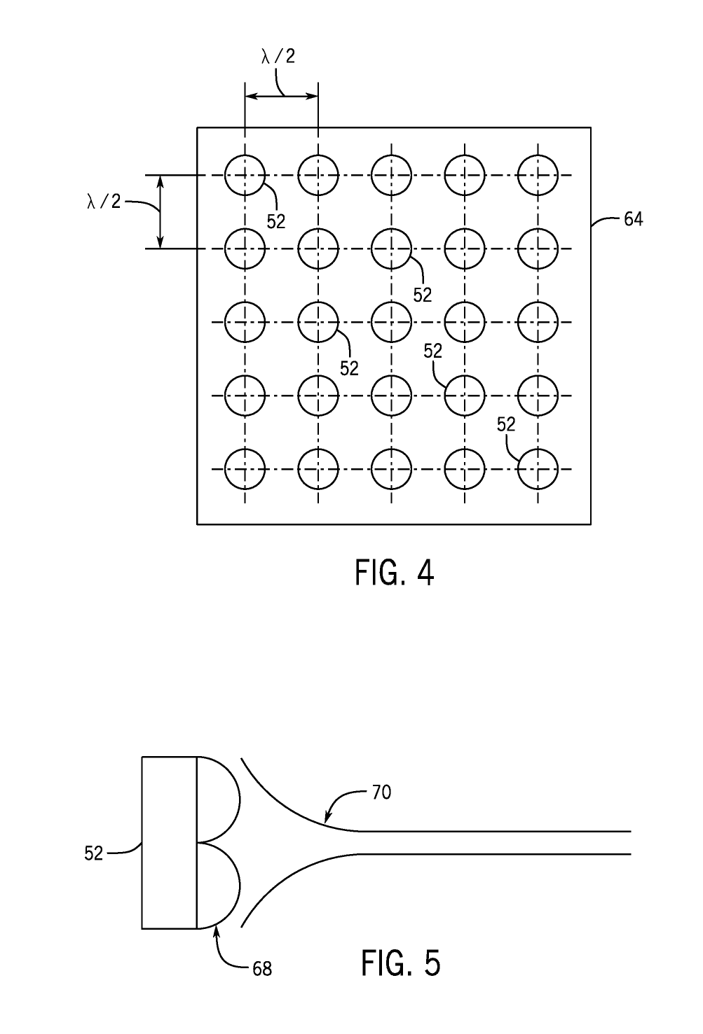

Although a single transmitting transducer 52 could be used, a transducer array 64 is used to transmit acoustic waves 46 in at least some cases, as generally depicted in FIG. 3. A multidimensional transducer array 64 may include multiple transducers 52 made with piezoelectric materials, such as PZT, crystal, or tonpilz transducers used to transmit acoustic power subsea. One example of such a transducer array 64 is depicted in FIG. 4. Although presently depicted as a five-by-five array of twenty-five transducers 52, it will be appreciated that other array sizes can be used (e.g., a sixteen-by-sixteen array with two hundred fifty-six transducers 52). In at least some embodiments, transducer arrays 64 are PZT arrays having ultrasonic transducers with PZT-2, PZT-4, or PZT-8 ceramics, which are hard ceramics capable of transmitting acoustic power. The transducers 52 of the array 64 can be spaced at intervals that are half the wavelength (i.e., λ/2) of their emitted acoustic waves.

In FIG. 3, a beamformer 66 is operatively coupled to the transducer array 64 to control its acoustic wave output. The beamformer 66 can control operation of the transducers 52 of the array 64 to form a largely non-dispersive, narrow, directional beam, such as by applying electrical signals to individual transducers 52 in a desired sequence to control excitement of piezoelectric elements of the transducers to create an interference pattern that produces the directional beam. The beamformer 66 can also be used for three-dimensional beam steering. That is, the resulting beam of acoustic energy can be steered in more than one dimension (e.g., in elevational and azimuthal directions) to transmit the acoustic energy in a desired direction. In FIG. 1, for example, a narrow beam of ultrasonic energy can be transmitted from the ROV 26, the buoy 30, or the submersible 36 (by the transducer array 64 and the beamformer 66 of FIG. 3) and directed to a desired sensor 24 (and associated sensor power system) on the riser 16 or the wellhead assembly 18.

Whether used as a single transmitting element or used as part of a transmitting array 64, a transducer 52 can also include an acoustic lens 68 to focus acoustic energy and form a narrow acoustic energy beam 70, as generally depicted in FIG. 5. By way of example, the acoustic lens 68 is shown in FIG. 5 as a logarithmic lens that can be used to collimate the beam 70 from the transducer 52. But it will be appreciated that any suitable acoustic lens 68 could be used in other embodiments. The acoustic lens 68 could be a Fresnel lens, for instance, which uses diffraction to collimate the acoustic beam 70.

Acoustic energy can be communicated via acoustic waves of any suitable frequency, such as sonic waves (20 Hz-20 kHz) or ultrasonic waves (above 20 kHz) In at least some embodiments, the acoustic energy is transmitted via acoustic waves 46 within a frequency range of 10 kHz-10 MHz. The frequency can be selected based on the distance from the transmitter (e.g., transducer 52 or transducer array 64) to the receiver connected to sensor 24. Electrical excitation waveforms from a signal generator to transmitting transducers can take various forms, such as sinusoidal or square waves that may be continuous or pulsed. The acoustic waveforms are pressure waves, which are plane waves or longitudinal waves, with a velocity of propagation specific to fluid density, bulk modulus, shear modulus, temperature, and pressure. Transmission loss can be calculated based on the spreading loss as a function of distance and attenuation of sound in the transmission medium (e.g., seawater). Because attenuation is a function of frequency, transmitting transducers can be operated from 1 meter to 10,000 meters in the frequency range from 10 MHz to 1 kHz in at least some instances. The amount of signal level generated depends on the radiated power of the transmitters and its directivity. In some embodiments, acoustic power output can range from 0.1 watts to 10,000 watts, thereby generating a source level of 160 dB to 230 dB. In cases of a transmitter using multiple transducers 52 (e.g., transducer array 64), the overall aperture size of the transmitter can be determined by arranging individual transducers 52 in parallel at low frequencies and power generated can be proportional to the overall area of the transmitter with the individual transducers 52.

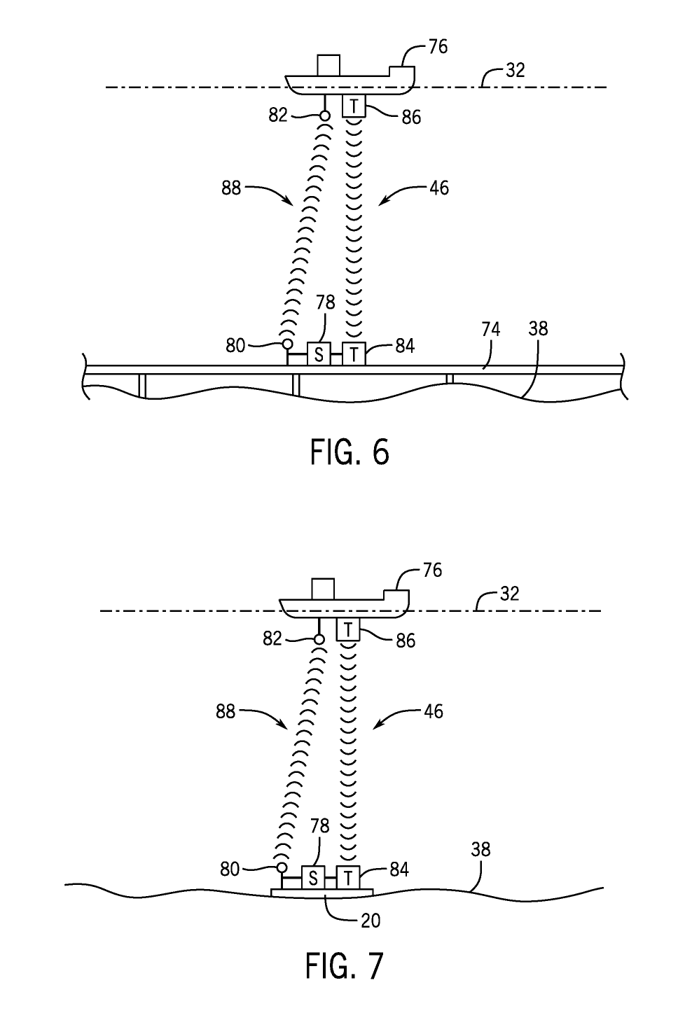

Although acoustic energy can be used to provide operational power for sensors 24 of the riser 16 and equipment of the wellhead assembly 18 (e.g., blowout preventers), the present techniques may be used to power sensors in other systems and for different applications. As shown in FIG. 6, for example, a subsea installation includes a pipeline 74 (e.g., a tieback line between subsea equipment) along a seabed 38 that receives acoustic waves 46 from a ship 76 or other vessel, and the acoustic energy received via the waves 46 are used to power one or more sensors 78 of the pipeline 74. Further, in this depicted embodiment, data acquired with the sensors 78 is wirelessly communicated from the pipeline 74 to the ship 76 via acoustic modems 80 and 82. That is, acoustic waves 46 can be used to convey acoustic energy from a transmitter at the ship 76 (e.g., transducer 86) to a receiver at the pipeline 74 (e.g., transducer 84), the received acoustic energy can be used to provide operational power to the sensors 78, and data from the sensors 78 can be communicated to the ship 76 via acoustic waves 88. In other embodiments, data acquired by the sensors 78 could be communicated in some other manner or could be stored for later collection. The sensors 78 can be designed to measure various parameters of interest, but in at least some embodiments the sensors 78 are used to measure pipe wall thickness of the pipeline 74 and to measure flow through the pipeline 74.

The acoustic energy received by the transducer 84 can be converted to electric power appropriate for the sensors 78, such as with an AC/DC converter and an amplifier as described above. The electric power may be provided directly to the sensors 78 or be used to charge a battery or other energy storage device from which the sensors 78 draw power. The transducers 84 and 86 can take any suitable form, such as the individual transducers or transducer arrays described above. Further, the resulting electric power can also be used to operate the acoustic modem 80 and allow data transmission. And while the pipeline 74 and the ship 76 are presently depicted with acoustic modems 80 and 82 distinct from the transducers 84 and 86, in other embodiments the transducers 84 and 86 could be used to communicate both power and data between the pipeline 74 and the ship 76.

In other embodiments, acoustic energy may be used to provide operational power to one or more sensors 78 that monitor an abandoned well, such as for potential leaking. As shown in FIG. 7, for example, sensors 78 can communicate data from an abandoned well (i.e., a subsea installation generally represented by wellhead 20) to a ship 76 via the acoustic modems 80 and 82. Operational power for the sensors 78 and the acoustic modem 80 can be generated from acoustic energy communicated (via waves 46) to a receiving transducer 84, as described above. In still other embodiments, such a power transmission and data communication system can be used with sensors on other equipment, such as other subsea drilling or production equipment, onshore or surface oilfield equipment, or even non-oilfield installations.

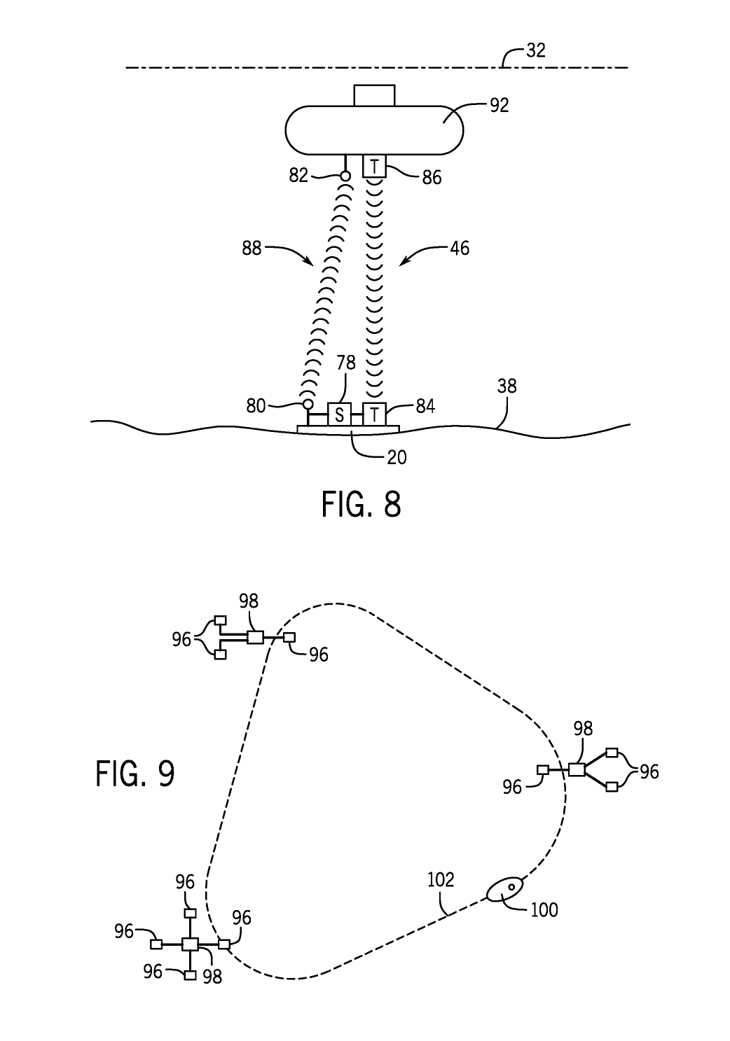

Although ships 76 are depicted along the surface 32 of the water in FIGS. 6 and 7 for sending acoustic energy to the subsea sensors 78 and for receiving data acquired with the sensors 78, it will be appreciated that other vessels could also or instead be used. As shown in FIG. 8, for example, an autonomous underwater vehicle (AUV) 92 is used to emit acoustic energy to a receiving transducer 84 for providing operational power to sensors 78 and to receive data from such sensors 78.

In some embodiments, a vessel can travel to different subsea installations to provide acoustic power to and collect data from sensors of those installations. This may facilitate periodic monitoring of active or abandoned subsea wells, equipment, and pipelines. One such embodiment is depicted in FIG. 9, in which three subsea installations, each generally shown as having well equipment 96 and additional equipment 98, are visited by a vessel 100, such as ship 76 or AUV 92. The well equipment 96 can include wellheads, blowout preventers, lower marine riser packages, risers, or trees, while the additional equipment 98 can include subsea manifolds, pumping stations, production facilities, or pipelines, for example. The equipment 96 and 98 can include sensors (e.g., sensors 24 or 78) for acquiring data at the subsea installations.

In this example, the vessel 100 travels along a route 102 toward each of the three depicted subsea installations. Once within a desired acoustic range of a subsea installation, the vessel 100 can convey acoustic energy to that subsea installation (e.g., from transducer 86), which can be received (e.g., at transducer 84) and converted to electric power used to operate sensors at the subsea installation, as described above. Data acquired with the sensors can be wirelessly communicated back to the vessel 100, such as with acoustic modems 80 and 82. The vessel 100 can then be moved toward additional subsea installations to provide acoustic power for operating sensors of those installations and to collect data from those sensors in similar fashion.

In at least one instance, the vessel 100 is an autonomous vehicle that can automatically (without human intervention): travel between the subsea installations along the route 102 (which may be a predetermined route), transmit acoustic energy to the subsea installations that can be used to provide operational power to sensors of the installations, and acquire data transmitted to the vessel 100 from the subsea installations. Although three subsea installations are depicted in FIG. 9, the vessel 100 can be used to provide power to and collect data from some other number of installations. In some embodiments, for example, the vessel 100 can be used to provide power to and collect data from dozens or hundreds of sensors spread among numerous subsea installations. And in at least one embodiment, the vessel 100 can be used to monitor multiple abandoned wells of one or more oil fields. The vessel 100 can travel along the route 102 continually or periodically (e.g., once per week or once per month), depending on the desired frequency of data collection. Although the route 102 is depicted in FIG. 9 as passing over a portion of each subsea installation, it will be appreciated that the travel route 102 may vary based on the acoustic range of the vessel's transmitter and that the vessel 100 may be able to provide power to and receive data from the subsea installations without passing over them.

In at least some embodiments, such as any of the subsea embodiments described above, one or more sensor locating techniques may be used to facilitate transmission of acoustic energy toward sensors. In some examples, a homing signal can be generated from an acoustic modem 80, an acoustic transducer 54 or 84 that produces electric power for a sensor 24 or 78, or from an additional acoustic transducer that is near (e.g., connected in parallel with) the transducer 54 or 84. Such devices operable to send a homing signal may be referred to as a homing beacon, and the homing signal can be a transmitted pulse (e.g., a short pulse) that is received by the acoustic transducer 52 or 86 (or another nearby sensor) and used to determine a direction or location of the sensor 24 or 78 with respect to the acoustic transducer 52 or 86. A multidimensional transducer array, such as the array 64, can be operated to transmit acoustic energy to receiving transducers 52 or 86, as described above, but could also be operated as a receiving antenna to receive the homing signal (e.g., at vessel 100) and facilitate locating of the sensor. In some instances, the acoustic transducer 52 or 86 can be employed as a sonar system to locate the sensors subsea using a pulse echo approach and imaging, via echo location, or via an acoustic modem. In other embodiments, the positions of the components can be used to determine the direction in which the acoustic energy should be transmitted. For example, positions of the sensors and associated acoustic receivers can be stored (e.g., as coordinates of a three-dimensional rectangular or cylindrical coordinate system), the position of the acoustic transmitter can be determined (e.g., via a global positioning system), and the direction in which acoustic energy is focused can be determined based on the relative positions of the acoustic transmitter and the intended acoustic receiver.

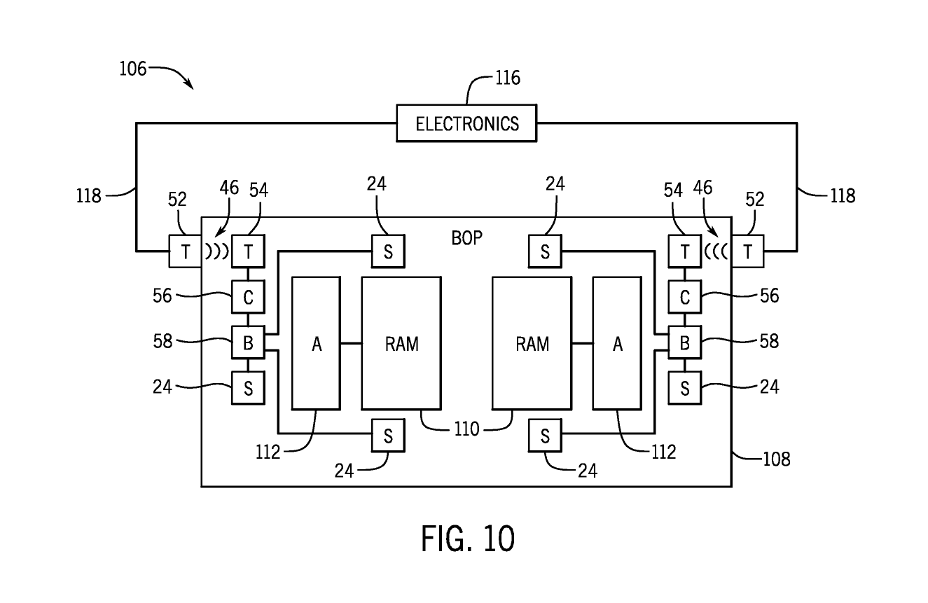

In still other embodiments, acoustic energy is used to provide operational power for sensors installed inside drilling or production equipment (e.g., equipment of wellhead assembly 18), with the acoustic energy transmitted through a body of the equipment from an external acoustic transmitter to an acoustic receiver inside the body. An apparatus 106 is depicted in FIG. 10 as an example, in which acoustic energy is used to power sensors 24 within a blowout preventer body 108. The blowout preventer can be provided as part of the wellhead assembly 18, and could be located offshore (subsea or on the surface) or onshore in various instances. As presently depicted, the blowout preventer is a ram-type preventer with rams 110 that are controlled by actuators 112, but it is noted that the blowout preventer could instead be an annular preventer.

In this embodiment, acoustic transmitters in the form of acoustic transducers 52 are provided on an exterior of the blowout preventer body 108, and these transducers 52 emit acoustic waves 46 through walls of the blowout preventer body 108 to acoustic receivers (e.g., transducers 54) within the body 108. The acoustic transducers 52 can be powered by electronics 116 (e.g., power supply and conditioning circuitry) via cables 118. In subsea environments, the cables 118 can be water block cables or pressure-balanced oil-filled (PBOF) cables. The acoustic receivers generate electric power from the received acoustic waves 46, which may be converted (via converters 56) and supplied to batteries 58 or sensors 24, as discussed above. In at least some embodiments, the transducers 52 and 54 are ultrasonic transducers. The sensors 24 within the blowout preventer body 108 could be used for various purposes, such as for measuring an environmental condition (e.g., pressure or temperature) within the blowout preventer, for detecting the position of the rams 110 or actuators 112, or for sensing or characterizing fluid within the blowout preventer. In other instances, a transducer 54 and a sensor 24 can be positioned inside a wellhead 20, the transducer 54 generates electric power from acoustic waves 46 received from the transducer 52 through the body of the wellhead 20, and this generated electric power is used for operating the sensor 24 (e.g., for measuring annulus pressure or temperature inside the wellhead 20).

While the aspects of the present disclosure may be susceptible to various modifications and alternative forms, specific embodiments have been shown by way of example in the drawings and have been described in detail herein. But it should be understood that the invention is not intended to be limited to the particular forms disclosed. Rather, the invention is to cover all modifications, equivalents, and alternatives falling within the spirit and scope of the invention as defined by the following appended claims.

1. An apparatus comprising:
a subsea installation in a body of water, the subsea installation including a sensor and an acoustic receiver; and
an acoustic transmitter separated from the acoustic receiver and arranged to transmit acoustic waves to the acoustic receiver using the body of water as a transmission medium for the acoustic waves;
wherein the acoustic receiver is coupled to the sensor so as to allow the sensor to be powered with electricity generated from receipt of the acoustic waves from the acoustic transmitter by the acoustic receiver.

2. The apparatus of claim 1, wherein the subsea installation includes a subsea well installation having the sensor.

3. The apparatus of claim 2, wherein the subsea well installation includes a wellhead assembly having the sensor or a marine riser having the sensor.

4. The apparatus of claim 1, wherein the acoustic transmitter includes an ultrasonic transducer array configured to output a beam of acoustic energy steerable in both azimuthal and elevational directions so as to direct the beam of acoustic energy toward the acoustic receiver.

5. The apparatus of claim 1, comprising a converter connected between the acoustic receiver and the sensor to convert alternating current power from the acoustic receiver into direct current power.

6. The apparatus of claim 5, wherein the sensor is connected to receive the direct current power directly from the converter.

7. The apparatus of claim 5, comprising an energy storage device, wherein the energy storage device is connected to receive the direct current power from the converter and to provide operational power to the sensor.

8. The apparatus of claim 1, wherein the subsea installation includes an acoustic modem that enables wireless transmission of data acquired by the sensor through the body of water.

9. An apparatus comprising:
a wellhead assembly mounted over a well;
a sensor installed at the wellhead assembly; and
a sensor power system connected to provide operational power for the sensor installed at the wellhead assembly, the sensor power system including:
an acoustic receiver that receives acoustic energy and converts the acoustic energy into alternating current (AC) power; and
a converter that receives the AC power from the acoustic receiver and converts the AC power into direct current (DC) power that facilitates the provision of operational power to the sensor installed at the wellhead assembly.

10. The apparatus of claim 9, wherein:
the wellhead assembly includes a blowout preventer;
the sensor, the acoustic receiver, and the converter are installed within the blowout preventer; and
the apparatus comprises an acoustic transmitter that is positioned outside the blowout preventer to enable transmission of the acoustic energy from the acoustic transmitter outside the blowout preventer to the acoustic receiver within the blowout preventer through a body of the blowout preventer.

11. The apparatus of claim 10, wherein the sensor is configured to measure an environmental condition within the blowout preventer.

12. The apparatus of claim 10, wherein the sensor is configured to detect the position of a ram within the blowout preventer.

13. The apparatus of claim 9, wherein the sensor power system includes an energy storage device connected to receive the DC power from the converter and to enable the sensor to receive the operational power from the energy storage device.

14. The apparatus of claim 9, wherein the wellhead assembly mounted over the well is a subsea wellhead assembly mounted over a subsea well.

15. A method comprising:
receiving acoustic energy at a subsea installation;
converting the received acoustic energy into electrical energy; and
powering a sensor of the subsea installation with the electrical energy.

16. The method of claim 15, wherein receiving acoustic energy at the subsea installation includes receiving ultrasonic energy at the subsea installation and converting the received acoustic energy into electrical energy includes converting the received ultrasonic energy into the electrical energy.

17. The method of claim 15, wherein converting the received acoustic energy into electrical energy includes generating an alternating current electric signal at an acoustic receiver in response to the received acoustic energy and converting the alternating current electric signal into a direct current electric signal.

18. The method of claim 17, wherein powering the sensor of the subsea installation with the electrical energy includes charging an energy storage device with the direct current electric signal and powering the sensor of the subsea installation with the energy storage device.

19. The method of claim 15, comprising acquiring data from the subsea installation and from an additional subsea installation, wherein such acquiring includes:
moving a vessel toward the subsea installation;
conveying the acoustic energy from the vessel, via an acoustic transmitter, to an acoustic receiver of the subsea installation to facilitate the conversion of the received acoustic energy into electrical energy for powering the sensor of the subsea installation;
wirelessly communicating data acquired with the sensor of the subsea installation to the vessel;
moving the vessel toward the additional subsea installation;
conveying acoustic energy from the vessel, via the acoustic transmitter, to an acoustic receiver of the additional subsea installation;
converting the acoustic energy received by the acoustic receiver of the additional subsea installation into electrical energy used to power a sensor of the additional subsea installation; and
wirelessly communicating data acquired with the sensor of the additional subsea installation to the vessel.

20. The method of claim 19, wherein conveying the acoustic energy from the vessel, via the acoustic transmitter, to the acoustic receiver of the subsea installation includes receiving a homing signal from the subsea installation and transmitting the acoustic energy from the vessel in a direction of the acoustic receiver based on the homing signal.
